(19) United States
(12) Patent Application Publication
(10) Pub. No.: US 2022/0116063 A1
(43) Pub. Date: Apr. 14, 2022

(54) SIGNAL PROCESSING APPARATUS, COMMUNICATION SYSTEM, AND SIGNAL PROCESSING METHOD

(71) Applicant: NEC Corporation, Tokyo (JP)

(72) Inventor: Yoichi KATAKAI, Tokyo (JP)

(73) Assignee: NEC Corporation, Tokyo (JP)

(21) Appl. No.: 17/492,930

(22) Filed: Oct. 4, 2021

(30) Foreign Application Priority Data
Oct. 9, 2020 (JP) 2020-171227

(51) Int. Cl. H04B 1/04; H04B 1/00

(52) U.S. Cl. CPC H04B 1/0475; H04B 2001/0425; H04B 1/0057

(57) ABSTRACT

An example object of the present disclosure is to provide a signal processing apparatus, a communication system, a signal processing method, and a program for accurately compensating for a nonlinear distortion of a signal. A signal processing apparatus 1 according to an example embodiment includes at least one memory configured to store an instruction, and at least one processor configured to execute the instruction, the processor being further configured to compensate for a nonlinear distortion component of at least one input signal containing a nonlinear distortion among a plurality of multiplexed input signals, output the compensated input signal, and generate a plurality of separated signals by separating the plurality of input signals including the output signal.

### INCORPORATION BY REFERENCE

This application is based upon and claims the benefit of priority from Japanese patent application No. 2020-171227, filed on Oct. 9, 2020, the disclosure of which is incorporated herein in its entirety by reference.

### TECHNICAL FIELD

The present disclosure relates to a signal processing apparatus, a communication system, a signal processing method, and a program.

### BACKGROUND ART

In a radio communication apparatus, there are some cases where a nonlinear distortion that depends on the characteristics of a nonlinear device provided in an analog part of the apparatus occurs and therefore desired communication characteristics cannot be obtained. In such cases, it is necessary to compensate for the nonlinear distortion in a digital part of the apparatus.

For example, it is stated in Japanese Patent No. 4019912 that in a demodulator, a Complex Mult 7 removes nonlinear distortions of input signals Ich3 and Qch3 by using a gain compensation signal G and a phase compensation signal θ output by a distortion compensator 8, and thereby outputs signals Ich4 and Qch4.

In recent years, technologies such as MIMO (Multiple Input Multiple Output) have been used in order to increase the speed of radio communication. In the MIMO, a transmitting apparatus transmits transmission signals from a plurality of respective transmitting antennas at the same time. Then, in a receiving apparatus, a plurality of receiving antennas receives the transmitted signals, and a signal separation unit separates the plurality of received signals into a plurality of transmission signals. In this way, the receiving apparatus can reproduce the transmission signals.

In general, a nonlinear device such as an amplifier for amplifying a received signal is provided inside a receiving apparatus, and a nonlinear distortion occurs in the received signal as the received signal passes through the nonlinear device. Note that signals output by a signal separation unit (i.e., transmission signals) are signals that are obtained by separating a plurality of signals in which a nonlinear distortion(s) has occurred. Therefore, there has been a possibility that, for example, when a separation method used in the signal separation unit is changed, the digital part, which attempts to compensate a signal output by the signal separation unit for its nonlinear distortion, cannot accurately compensate for the nonlinear distortion.

### SUMMARY

An example object of the present disclosure is to provide a signal processing apparatus, a communication system, a signal processing method, and a program for accurately compensating for a nonlinear distortion of a signal.

In a first example aspect, a signal processing apparatus includes at least one memory configured to store an instruction, and at least one processor configured to execute the instruction, the processor is further configured to: compensate for a nonlinear distortion component of at least one input signal containing a nonlinear distortion among a plurality of multiplexed input signals, output the compensated input signal; and generate a plurality of separated signals by separating the plurality of input signals including the output signal.

In another example aspect, a communication system includes one or a plurality of transmitting apparatuses configured to transmit a plurality of transmission signals, and a receiving apparatus configured to acquire a plurality of reception signals in each of which the plurality of transmission signals is multiplexed, wherein the receiving apparatus includes: a nonlinear device configured to output at least one of the plurality of reception signals; at least one memory configured to store an instruction; and at least one processor configured to execute the instruction, and the processor is further configured to: compensate for a nonlinear distortion component of at least one of the reception signals output from the nonlinear device, and output the compensated reception signal; and generate a plurality of separated signals by separating the plurality of reception signals including the output signal.

In another example aspect, a signal processing method includes: compensating for a nonlinear distortion component of at least one input signal containing a nonlinear distortion among a plurality of multiplexed input signals, and outputting the compensated input signal; and generating a plurality of separated signals by separating the plurality of input signals including the compensated input signal.

In another example aspect, a program for causing a computer to perform a signal processing method includes: compensating for a nonlinear distortion component of at least one input signal containing a nonlinear distortion among a plurality of multiplexed input signals, and outputting the compensated input signal; and generating a plurality of separated signals by separating the plurality of input signals including the compensated input signal.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a transmitter according to related art;

FIG. 2 is a block diagram showing a receiver according to the related art;

FIG. 3 is a block diagram showing a signal processing unit according to the related art;

FIG. 4 is a block diagram showing a relation among transmission signals, reception signals, and separated signals according to the related art;

FIG. 5 is a block diagram showing a signal processing apparatus according to a first example embodiment;

FIG. 6 is a block diagram showing a communication system according to the first example embodiment;

FIG. 7 is a block diagram showing transmitters according to a second example embodiment;

FIG. 8 is a block diagram showing a receiver according to the second example embodiment;

FIG. 9 is a block diagram showing a signal post-processing unit according to the second example embodiment;

FIG. 10 is a block diagram showing a signal pre-processing unit according to the second example embodiment;

FIG. 11 is a conceptual diagram showing a nonlinear distortion that occurs in a nonlinear device according to the second example embodiment;

FIG. 12 is a conceptual diagram showing a compensation characteristic of a reception linearizer according to the second example embodiment; and

FIG. 13 is a block diagram showing an example of a configuration of hardware of an information processing apparatus.

### EXAMPLE EMBODIMENT

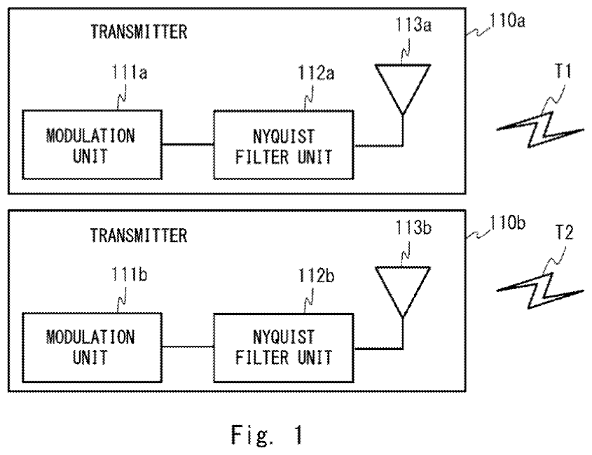

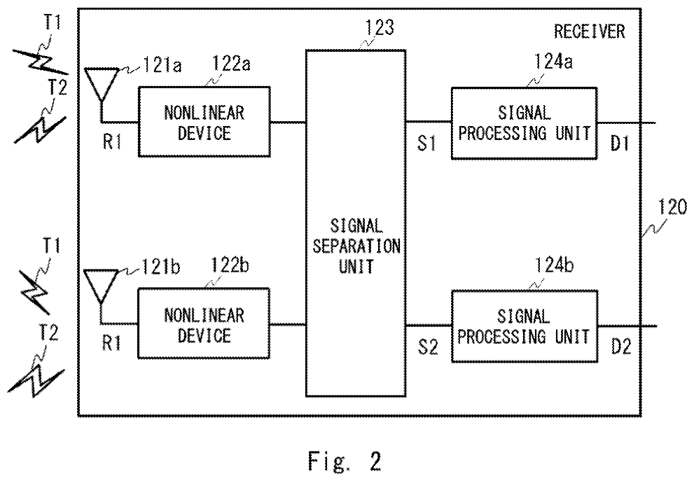

Firstly, a technique related to the present application (hereinafter also referred to as related art) will be described. FIGS. 1 and 2 show an example of a radio communication system using MIMO.

FIG. 1 shows a block diagram showing a transmitter according to the related art. Transmitters 110a and 110b are provided as apparatuses on a transmitting side in the radio communication system. The transmitter 110a includes a modulation unit 111a, a Nyquist filter unit 112a, and a transmitting antenna 113a.

The modulation unit 111a modulates a signal to be transmitted and outputs the modulated signal to the Nyquist filter unit 112a. The Nyquist filter unit 112a shapes the signal output from the modulation unit 111a and thereby generates a transmission signal T1. The transmitting antenna 113a wirelessly transmits the transmission signal T1. The transmitter 110b includes components similar to those of the transmitter 110a, and wirelessly transmits a transmission signal T2 by performing processes similar to those performed by the transmitter 110a.

FIG. 2 shows a block diagram showing a receiver according to the related art. The receiver 120 is an apparatus that receives the transmission signals T1 and T2 from the transmitters 110a and 110b, respectively, in a multiplexed state, and demodulates the received signals. The receiver 120 includes receiving antennas 121a and 121b, nonlinear devices 122a and 122b, a signal separation unit 123, and signal processing units 124a and 124b.

The receiving antenna 121a receives a reception signal R1 in which the transmission signals T1 and T2 are multiplexed, and the receiving antenna 121b receives a reception signal R2 in which the transmission signals T1 and T2 are multiplexed. In other words, each of the reception signals R1 and R2 is a composite wave of the transmission signals T1 and T2. The reception signals R1 and R2 pass through the nonlinear devices 122a and 122b, respectively, and are input to the signal separation unit 123. Each of the nonlinear devices 122a and 122b is, for example, an amplifier for amplifying a signal. As the reception signals R1 and R2 pass through the nonlinear devices 122a and 122b, respectively, nonlinear distortions occur in the reception signals R1 and R2.

The signal separation unit 123 separates the reception signals R1 and R2, in each of which the transmission signals T1 and T2 are multiplexed, into non-multiplexed signals (i.e., into separated signals S1 and S2). Note that nonlinear distortion components which occur in the nonlinear devices 122a and 122b have been added in the separated signals S1 and S2, respectively. The signal processing units 124a and 124b perform demodulation processes and processes for compensating for the nonlinear distortion components in the separated signals S1 and S2, respectively, and thereby generate demodulated signals D1 and D2, respectively.

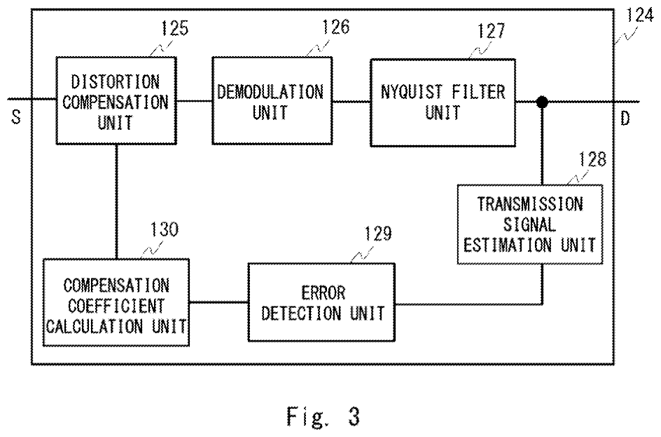

FIG. 3 shows a block diagram showing a signal processing unit 124. The signal processing unit 124 is a collective name for the signal processing units 124a and 124b. The signal processing unit 124 includes a distortion compensation unit 125, a demodulation unit 126, a Nyquist filter unit 127, a transmission signal estimation unit 128, an error detection unit 129, and a compensation coefficient calculation unit 130.

The distortion compensation unit 125 performs a process for compensating for the nonlinear distortion component of the separated signal S, and outputs the processed signal to the demodulation unit 126. The demodulation unit 126 demodulates the input signal and outputs the demodulated signal to the Nyquist filter unit 127. The Nyquist filter unit 127 shapes the output signal and thereby generates a demodulated signal D.

The transmission signal estimation unit 128 estimates the transmission signal T by using the input demodulated signal D, and outputs the estimated transmission signal T to the error detection unit 129. The error detection unit 129 detects an error (i.e., a difference) between the estimated transmission signal T and the demodulated signal D, and outputs information about the detected error (hereinafter also referred to as error information) to the compensation coefficient calculation unit 130. This error information results from the nonlinear distortion caused by the nonlinear device 122. The compensation coefficient calculation unit 130 calculates a compensation coefficient, which will be used in the distortion compensation unit 125, based on the error information, and outputs the calculated compensation coefficient to the distortion compensation unit 125. The distortion compensation unit 125 performs a process for compensating for the nonlinear distortion component of the separated signal S by using this compensation coefficient. The signal processing units 124a and 124b generate the demodulated signals D1 and D2, respectively, by performing the above-described processes.

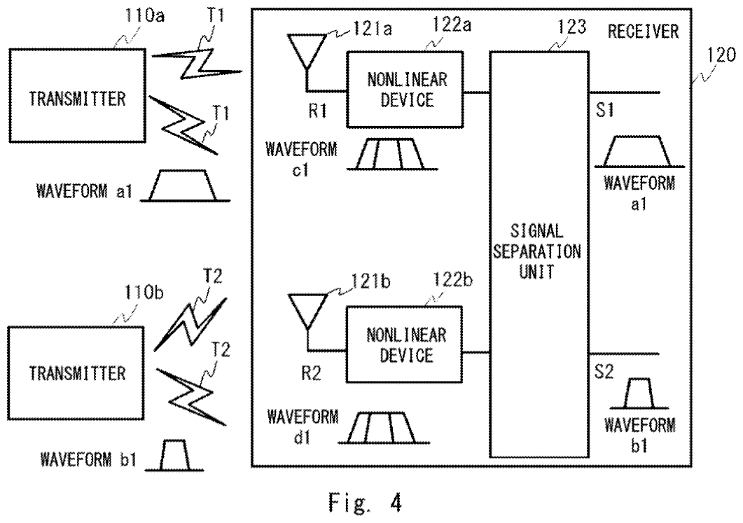

FIG. 4 is a schematic diagram showing a relation among the transmission signals T1 and T2, the reception signals R1 and R2, and the separated signals S1 and S2. The transmitter 110a outputs a transmission signal T1 having a waveform al, while the transmitter 110b outputs a transmission signal T1 having a waveform bl. The receiving antenna 121a receives a reception signal R1 in which the transmission signals T1 and T2 are multiplexed. As the transmission signals T1 and T2 are multiplexed, the reception signal R1 has a waveform like a waveform cl shown in FIG. 4. Further, the receiving antenna 121b receives a reception signal R2 in which the transmission signals T1 and T2 are multiplexed. As the transmission signals T1 and T2 are multiplexed, the reception signal R2 has a waveform like a waveform dl shown in FIG. 4. Then, the signal separation unit 123 separates the reception signals R1 and R2 from each other, and thereby outputs a separated signal S1 having a waveform al and a separated signal S2 having a waveform bl. Note that, in FIG. 4, illustration of the nonlinear distortion components caused by the nonlinear devices 122a and 122b are omitted. In this way, the receiver 120 demodulates the waveforms of the transmission signals T1 and T2.

In the above-described configuration of the transmitter, the nonlinear devices 122a and 122b cause nonlinear distortions in the reception signals R1 and R2 in which the transmission signals T1 and T2 are multiplexed. The degrees of these nonlinear distortions depend on the strengths of the reception signals R1 and R2. However, the signal input to the distortion compensation unit 125, which compensates for the distortion of the signal, is the separated signal S, which is obtained by separating the multiplexed signals. Therefore, there has been a possibility that the distortion compensation unit 125 cannot correctly estimate the nonlinear distortion characteristic of the nonlinear device 122. In such a case, there is a possibility that the receiver 120 cannot accurately compensate for the nonlinear distortion. The present disclosure provides a configuration by which the above-described problem can be solved.

### First Example Embodiment

(1-1)

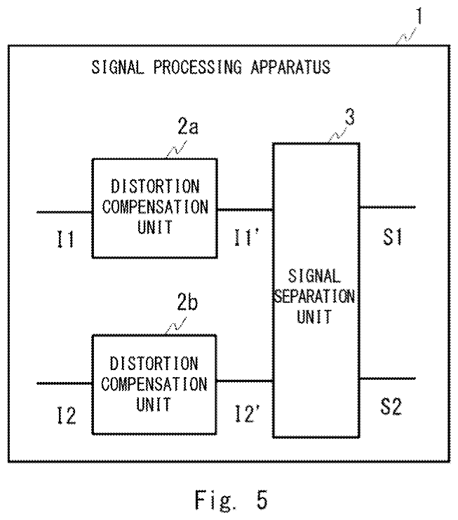

A first example embodiment according to the present disclosure will be described hereinafter with reference to the drawings. FIG. 5 shows a block diagram showing a signal processing apparatus according to the first example embodiment. The signal processing apparatus 1 can be applied, for example, to an apparatus that demodulates a signal, such as a receiving apparatus in a communication system, but the applications thereof are not limited to such apparatuses. The signal processing apparatus 1 includes distortion compensation unit 2a and 2b, and a signal separation unit 3. Each of the components will be described hereinafter.

Each of input signals I1 and I2 is a signal in which a plurality of signals is multiplexed, and contains a nonlinear distortion. The distortion compensation units 2a and 2b are disposed in front of (i.e., on the input side of) the signal separation unit 3, and compensate for the nonlinear distortion components of the input signals I1 and I2, respectively, and thereby output input signals I1′ and I2′, which have been compensated for the nonlinear distortion components, to the signal separation unit 3. Note that the input signals I1 and I2 may be output from a nonlinear device(s) provided inside the signal processing apparatus 1, or from a nonlinear device(s) provided outside the signal processing apparatus 1. Further, the expression “compensating for a nonlinear distortion component” means entirely or partially eliminating the nonlinear distortion component.

The signal separation unit 3 generates a plurality of separated signals S1 and S2 by separating the input signals I1′ and I2′ based on a predetermined algorithm. That is, the signal separation unit 3 generates separated signals S1 and S2 by performing a process for separating multiplexed signals.

By the above-described configuration, the signal processing apparatus 1 generates a plurality of separated signals by using a plurality of input signals including a compensated input signal(s). Therefore, as compared to the configuration according to the related art in which the distortion compensation unit is provided behind (i.e., on the output side of) the signal separation unit, it is possible to accurately compensate for a nonlinear distortion(s) in a signal(s). For example, the signal processing apparatus according to the first example embodiment can accurately compensate for a nonlinear distortion in a signal even when the separation method in the signal separation unit 3 is changed.

In the above-described example, the signal separation unit 3 generates the separated signals S1 and S2 by using the input signals I1′ and I2′. However, each of the number of channels of the input signals and that of the separated signals is not limited to two, but may be any number equal to or larger than three.

In FIG. 5, the distortion compensation units 2a and 2b compensate for the nonlinear distortion components of the input signals I1 and I2, respectively. However, the distortion compensation unit 2 may compensate for only one of the nonlinear distortion components of the input signals I1 and I2, instead of compensating for both of them. Further, a nonlinear distortion may be contained in only one of the input signals I1 and I2. In such a case, the distortion compensation unit 2 compensates for the nonlinear distortion component of the input signal that contains the nonlinear distortion.

Further, even in the case where the input signals have three or more channels, the distortion compensation unit 2 may compensate for a nonlinear distortion component(s) of any number of channels of at least one input signal I containing a nonlinear distortion, and output the compensated signal(s) to the signal separation unit 3. In such a configuration, the signal separation unit 3 generates a plurality of separated signals S by using a plurality of input signals I including a compensated input signal(s) I, and therefore can generate the separated signals S which have been accurately compensated for the nonlinear distortion(s).

(1-2)

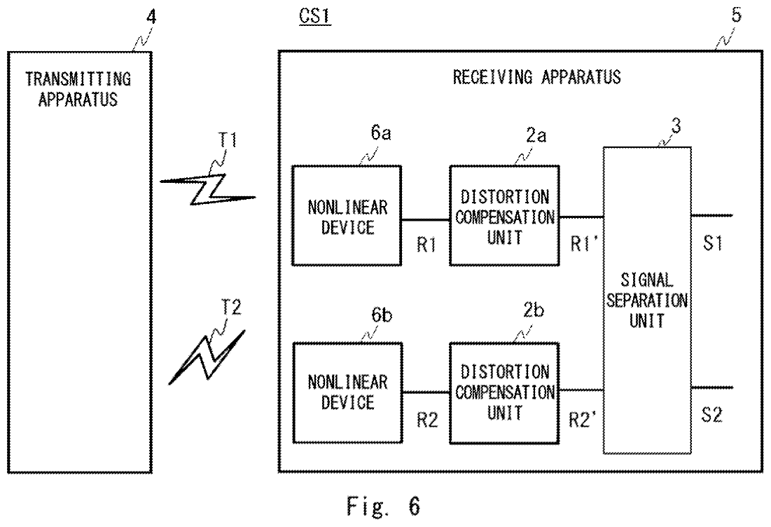

Next, an example in which the configuration of the signal processing apparatus 1 is applied to a communication system is shown. FIG. 6 shows a block diagram showing a communication system according to the first example embodiment. The communication system CS1 includes a transmitting apparatus 4 and a receiving apparatus 5.

The transmitting apparatus 4 wirelessly transmits a plurality of transmission signals T1 and T2, and the receiving apparatus 5 receives the transmission signals T1 and T2 and thereby acquires a plurality of reception signals R1 and R2 in each of which the transmission signals T1 and T2 are multiplexed. For example, the transmitting apparatus 4 wirelessly transmits the transmission signals T1 and T2, and the receiving apparatus 5 acquires reception signals R1 and R2 in each of which the transmission signals T1 and T2 are spatially multiplexed. The receiving apparatus 5 includes nonlinear devices 6a and 6b, as well as the above-described distortion compensation units 2a and 2b, and the signal separation unit 3.

As signals are input from, for example, receiving units such as antennas to the nonlinear devices 6a and 6b, they output a plurality of reception signals R1 and R2, respectively. Because of these nonlinear devices 6a and 6b, nonlinear distortions occur in the reception signals R1 and R2, respectively. Further, the plurality of reception signals R1 and R2 correspond to the input signals I1 and I2 in the above-described Section (1-1).

The distortion compensation units 2a and 2b compensate the nonlinear distortion components of the reception signals R1 and R2, respectively, and output them as reception signals R1′ and R2′, respectively. The signal separation unit 3 separates the reception signals R1′ and R2′ output from the distortion compensation units 2a and 2b, respectively, and thereby outputs separated signals S1 and S2, respectively. These separated signals S1 and S2 are, for example, a plurality of signals for demodulating the transmission signals T1 and T2. By the above-described configuration, the receiving apparatus 5 can accurately compensate for the nonlinear distortions caused by the nonlinear devices 6a and 6b by using the distortion compensation units 2a and 2b, respectively, provided inside the receiving apparatus 5.

Note that the transmitting apparatus 4 may transmit the plurality of transmission signals T1 and T2 through cables, instead of wirelessly transmitting them. Further, a plurality of transmitting apparatuses 4 may be provided, instead of being provided with only one transmitting apparatus 4. Further, the number of channels of the transmission signals T is not limited to two, but may be any number equal to or larger than three. In this example, it is assumed that, even when the transmitting apparatus 4 transmits transmission signals T having three or more channels, at least two multiplexed transmission signals T are contained in at least one reception signal R acquired by the receiving apparatus 5.

Further, each of the number of channels of the reception signals R and that of the separated signals S is not limited to two, but may be any number equal to or larger than three. The number of nonlinear devices 6 is not limited to two, but may be any number. That is, only one nonlinear device 6 may be provided, or three or more nonlinear devices 6 may be provided. In other words, the number of channels of nonlinearly-distorted reception signals may be only one or may be three or larger. Further, the configuration of the nonlinear device 6 is not limited to the single-input/single-output configuration, but may be a multiple-input/multiple-output configuration.

Further, the distortion compensation unit 2 may compensate for the nonlinear distortion component of only one of the reception signals R1 and R2, instead of compensating for those of both of them. Further, a nonlinear distortion may be contained in only one of the reception signals R1 and R2. In such a case, the distortion compensation unit 2 compensates for the nonlinear distortion component of the reception signal that contains the nonlinear distortion.

Further, even in the case where the reception signals R have three or more channels, the distortion compensation unit 2 may compensate for a nonlinear distortion component(s) of any number of channels of at least one reception signal R containing a nonlinear distortion, and output the compensated signal(s) to the signal separation unit 3.

### Second Example Embodiment

A second example embodiment according to the present disclosure will be described hereinafter with reference to the drawings. In the second example embodiment, the process for separating signals shown in the first example embodiment is described while showing a specific example in a detailed manner.

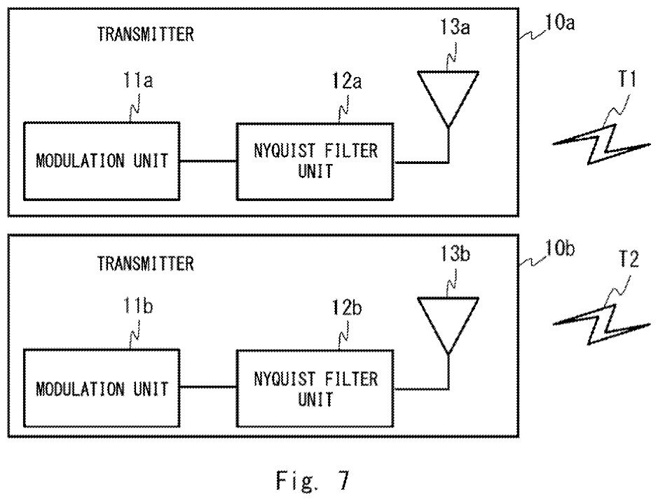

FIG. 7 shows a block diagram showing transmitters according to the second example embodiment. A transmitter 10a includes a modulation unit 11a, a Nyquist filter unit 12a, and a transmitting antenna 13a.

The modulation unit 11a is composed of a modulator, and modulates a signal to be transmitted and outputs the modulated signal to the Nyquist filter unit 12a. The Nyquist filter unit 12a shapes the signal output from the modulation unit 11a and thereby generates a transmission signal T1. The transmitting antenna 13a wirelessly transmits the transmission signal T1. A transmitter 10b includes components similar to those of the transmitter 10a, and wirelessly transmits a transmission signal T2 by performing processes similar to those performed by the transmitter 10a. The transmitters 10a and 10b may be provided as separate transmitters, or may be transmitters provided in one transmitting apparatus.

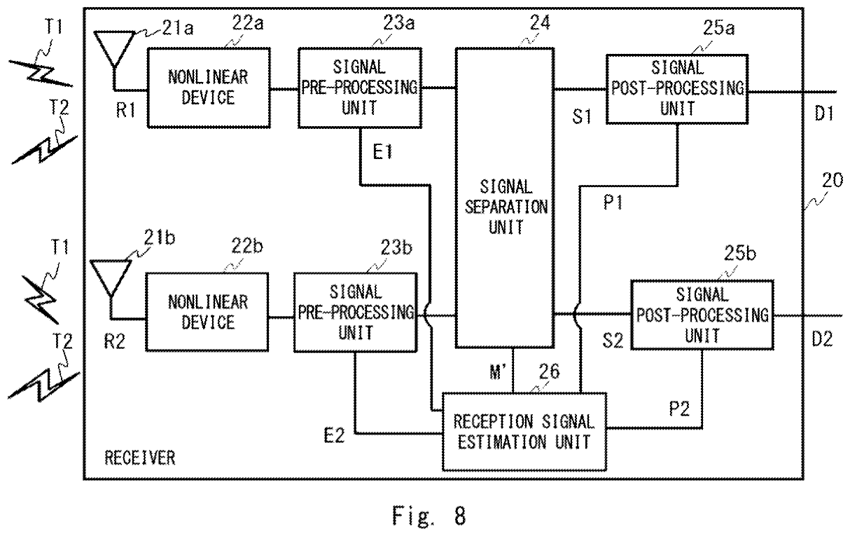

Next, a receiver according to the second example embodiment will be described with reference to FIG. 8. The receiver 20 is an apparatus that receives transmission signals from the transmitters 10a and 10b in a multiplexed state, and demodulates the received signals. The receiver 20 includes receiving antennas 21a and 21b, nonlinear devices 22a and 22b, signal pre-processing units 23a and 23b, a signal separation unit 24, signal post-processing units 25a and 25b, and a reception signal estimation unit 26.

The receiving antenna 21a acquires a reception signal R1 in which the transmission signals T1 and T2 are multiplexed, and the receiving antenna 21b acquires a reception signal R2 in which the transmission signals T1 and T2 are multiplexed. The reception signals R1 and R2 pass through the nonlinear devices 22a and 22b, respectively, and are input to the signal separation unit 24. Each of the nonlinear devices 22a and 22b is, for example, an amplifier for amplifying a signal. As the reception signals R1 and R2 pass through the nonlinear devices 22a and 22b, respectively, nonlinear distortions occur in the reception signals R1 and R2, respectively.

The signal pre-processing unit 23a is disposed between the nonlinear device 22a and the signal separation unit 24, and compensates for the nonlinear distortion of the reception signal R1 caused by the nonlinear device 22a. The signal pre-processing unit 23a outputs the reception signal R1, which has been compensated for the nonlinear distortion, to the signal separation unit 24. Note that the signal pre-processing unit 23a compensates for the nonlinear distortion by using a signal E1 which is a result of estimation of the reception signal R1 output by the reception signal estimation unit 26 (which will be described later).

The signal pre-processing unit 23b is disposed between the nonlinear device 22b and the signal separation unit 24, and compensates for the nonlinear distortion component of the reception signal R2 caused by the nonlinear device 22b. The signal pre-processing unit 23a outputs the reception signal R2, which has been compensated for the nonlinear distortion, to the signal separation unit 24. Note that the signal pre-processing unit 23b compensates for the nonlinear distortion by using a signal E2 which is a result of estimation of the reception signal R2 output by the reception signal estimation unit 26. Details of the signal pre-processing units 23a and 23b will be described later.

The signal separation unit 24 separates the reception signals R1 and R2, in each of which the transmission signals T1 and T2 are multiplexed, into non-multiplexed signals (i.e., into separated signals S1 and S2). These separated signals S1 and S2 are signals in which the transmission signals T1 and T2 are no longer multiplexed, and are signals for demodulating the transmission signals T1 and T2. The signal separation unit 24 outputs the separated signals S1 and S2 to the signal post-processing units 25a and 25b, respectively. Further, the signal separation unit 24 outputs, to the reception signal estimation unit 26, signal separation information M′ which the signal separation unit 24 used when it separated the reception signals R1 and R2 into the separated signals S1 and S2. Details of this signal separation information M′ will be described later. The signal post-processing unit 25a performs post-processing for the separated signal S1 output from the signal separation unit 24, and outputs a post-processed demodulated signal D1. The signal post-processing unit 25b performs post-processing for the separated signal S2 output from the signal separation unit 24, and outputs a post-processed demodulated signal D2.

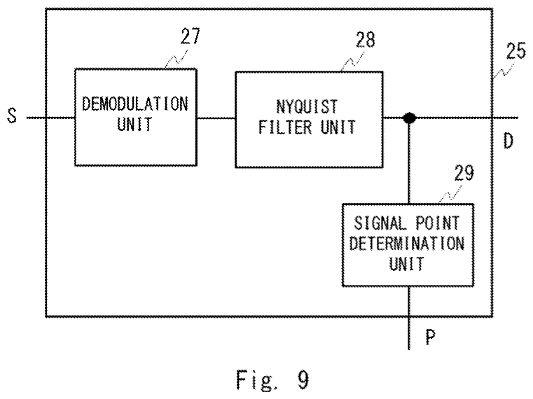

FIG. 9 is a block diagram showing a signal post-processing unit 25. The signal post-processing unit 25 is a collective name for the signal post-processing units 25a and 25b. The signal post-processing unit 25 includes a demodulation unit 27, a Nyquist filter unit 28 and a signal point determination unit 29. A configuration of the signal post-processing unit 25 and processes performed thereby are described hereinafter.

The demodulation unit 27 is composed of a demodulator, and demodulates the separated signal S1 and outputs the demodulated signal to the Nyquist filter unit 28. The Nyquist filter unit 28 shapes the signal output from the demodulation unit 27 and thereby outputs a demodulated signal D.

The demodulated signal D is input to the signal point determination unit 29. The signal point determination unit 29 determines a data signal point of the demodulated signal D and outputs the determined data signal point of the demodulated signal D to the reception signal estimation unit 26.

The explanation is continued by referring to FIG. 8 again. Data of the demodulated signals D1 and D2 output by the signal point determination units 29a and 29b, respectively, and the signal separation information M′ output by the signal separation unit 24 are input to the reception signal estimation unit 26. The reception signal estimation unit 26 estimates the reception signals R1 and R2 based on these inputs. The reception signal estimation unit 26 outputs a signal E1 which is a result of the estimation of the reception signal R1, and a signal E2 which is a result of the estimation of the reception signal R2 to the signal pre-processing units 23a and 23b, respectively. Note that the reception signals R1 and R2 estimated by the reception signal estimation unit 26 are input signals to the nonlinear devices 22a and 22b, respectively, and are signals in which no nonlinear distortion component resulting from the nonlinear devices 22a and 22b is contained.

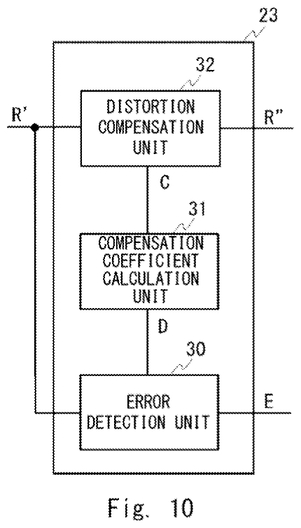

FIG. 10 is a block diagram showing a signal pre-processing unit 23. The signal pre-processing unit 23 is a collective name for the signal pre-processing units 23a and 23b. The signal pre-processing unit 23 includes an error detection unit 30, a compensation coefficient calculation unit 31 and a distortion compensation unit 32. A configuration of the signal pre-processing unit 23 and processes performed thereby are described hereinafter.

A signal E output by the reception signal estimation unit 26 and a reception signal R′ output by the nonlinear device 22 are input to the error detection unit 30. As described above, the reception signal R′ contains a nonlinear distortion component resulting from the nonlinear device 22. The error detection unit 30 detects an error (a difference) between the signal E, which is the result of the estimation of the reception signal R, and the reception signal R′, and outputs the detected error D to the compensation coefficient calculation unit 31. The compensation coefficient calculation unit 31 calculates a compensation coefficient C based on the error D and outputs the calculated compensation coefficient C to the distortion compensation unit 32. The distortion compensation unit 32 compensates for the nonlinear distortion of the reception signal R′ by using the compensation coefficients C and outputs the compensated reception signal as a reception signal R″ to the signal separation unit 24. The signal pre-processing units 23a and 23b compensate for the nonlinear distortions of the reception signals output from the nonlinear devices 22a and 22b, respectively by performing the above-described processes.

Operations of a reception linearizer which are performed by the receiver 20 according to the second example embodiment are described hereinafter in a supplemental manner. The reception linearizer means compensating a nonlinear distortion of a signal that occurs in the nonlinear device 22 such as an amplifier provided inside the receiving apparatus by having a digital circuit unit add an inverse characteristic of the nonlinear distortion to the signal.

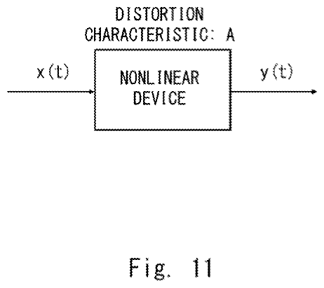

FIG. 11 shows a conceptual diagram of a nonlinear distortion that occurs in a nonlinear device. As an input signal x(t) passes through the nonlinear device having a distortion characteristic A, an output signal y(t) is output. Note that t represents the time.

When a memory polynomial is assumed as a model of the nonlinear distortion, a relation among a distortion characteristic coefficient aₘₖ, which constitutes the distortion characteristic A at a time to, the input signal x(t), and the output signal y(t) is expressed by the below-shown expression.

$$y ( {t}_{0} ) {\sum }_{m = 0}^{M - 1} {\sum }_{k = 0}^{K - 1} {a}_{mk} x ( {t}_{0 - m} ) {\vert x ( {t}_{0 - m} ) \vert}^{k} \qquad [ Expression 1 ]$$

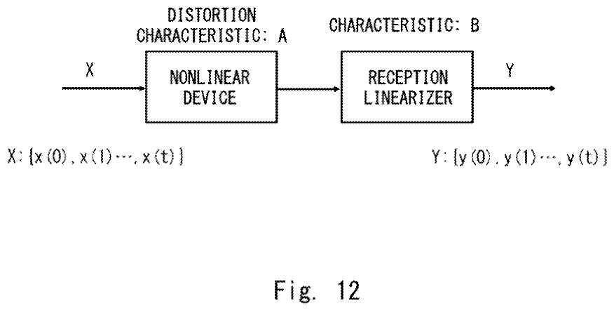

FIG. 12 is a conceptual diagram showing a compensation characteristic of a reception linearizer. In FIG. 12, a nonlinear distortion component occurs in a transmission signal X transmitted from a transmitting apparatus due to a nonlinear device having a distortion characteristic A disposed in front of the reception linearizer. The reception linearizer disposed behind the nonlinear device is provided so that it provides (i.e., adds) a characteristic B for compensating for the above-described distortion characteristic A to the signal, and as a result, a receiving apparatus obtains a transmission signal X.

In FIG. 12, when the output signal of the reception linearizer is represented by Y, a relation between the transmission signal X and the output signal Y is expressed as shown below.

Y=B·A·X

Here, in order to make the output signal Y identical to the transmission signal X, the characteristic B should be expressed as shown below.

B=A⁻¹.

Note that, as shown in FIG. 12, the input signal of the reception linearizer needs to be identical to the output signal of the nonlinear device.

Based on the above-described matters, a relation among the transmission signals T1 and T2, the reception signals R1 and R2, and the demodulated signals D1 and D2 in FIG. 8 will be described hereinafter. Firstly, a state in which the transmission signals T1 and T2 are spatially multiplexed and thereby become the reception signals R1 and R2 is expressed by the below-shown expression.

$$[ \begin{matrix}{R}_{1} \\ {R}_{2}\end{matrix} ] = M [ \begin{matrix}{T}_{1} \\ {T}_{2}\end{matrix} ] = [ \begin{matrix}a & b \\ c & d\end{matrix} ] [ \begin{matrix}{T}_{1} \\ {T}_{2}\end{matrix} ] \qquad [ Expression 2 ]$$

M in the above-shown expression represents a spatial multiplex matrix. In general, the spatial multiplex matrix M is unknown in the receiver 20. Therefore, for example, the receiver 20 estimates the spatial multiplex matrix and its inverse matrix in the signal separation unit 24 by using a predetermined known signal(s) periodically transmitted from the transmitters 10a and 10b. The receiver 20 may store information about the spatial multiplex matrix and its inverse matrix in a storage unit provided in the receiver 20 itself.

For example, the receiver 20 may store a waveform(s) of a predetermined signal(s) which is used as a sample of the transmission signal T in the storage unit, and determine that it is receiving the predetermined signal by comparing the waveforms of the demodulated signals D1 and D2 with the waveform(s) of the predetermined signal(s). As a result of the determination that the receiver 20 is receiving the predetermined signal(s), the receiver 20 estimates the spatial multiplex matrix and its inverse matrix and updates information thereabout so that the waveforms of the demodulated signals D1 and D2 become identical to the waveform(s) of the predetermined signal(s). In this way, the receiver 20 can generate accurate demodulated signals even when the multiplexing of transmission signals changes over time.

The signal separation unit 24 generates separated signals S1 and S2 by multiplying the reception signals by the inverse matrix M′⁻¹ of the estimated spatial multiplex matrix M′. As the separated signals S1 and S2 pass through the signal post-processing units 25a and 25b, respectively, they become demodulated signals D1 and D2, respectively.

The relation among the transmission signals T1 and T2, the reception signals R1 and R2, and the demodulated signals D1 and D2 is expressed by the below-shown expression.

$$[ \begin{matrix}{D}_{1} \\ {D}_{2}\end{matrix} ] = {M}^{′ - 1} [ \begin{matrix}{R}_{1} \\ {R}_{2}\end{matrix} ] = {[ \begin{matrix}{a}^{′} & {b}^{′} \\ {c}^{′} & {d}^{′}\end{matrix} ]}^{- 1} [ \begin{matrix}{R}_{1} \\ {R}_{2}\end{matrix} ] = {[ \begin{matrix}{a}^{′} & {b}^{′} \\ {c}^{′} & {d}^{′}\end{matrix} ]}^{- 1} [ \begin{matrix}a & b \\ c & d\end{matrix} ] [ \begin{matrix}{T}_{1} \\ {T}_{2}\end{matrix} ] \qquad [ Expression 3 ]$$

In the expression, since the reception signals R1 and R2 are signals different from the demodulated signals T1 and T2, it is difficult to calculate the compensation coefficient by directly using the demodulated signals D1 and D2.

Therefore, the receiver 20 performs error detection and calculation of the compensation coefficient as described below. Firstly, the signal separation unit 24 outputs the estimated spatial multiplex matrix M′ as signal separation information M′ to the reception signal estimation unit 26. This signal separation information M′ is information specific to MIMO. The reception signal estimation unit 26 obtains estimated values E1 and E2 of the reception signals R1 and R2 by multiplying the demodulated signals D1 and D2 by the spatial multiplex matrix M′. This calculation can be expressed by the below-shown expression.

$$[ \begin{matrix}{E}_{1} \\ {E}_{2}\end{matrix} ] = {M}^{′} [ \begin{matrix}{D}_{1} \\ {D}_{2}\end{matrix} ] = [ \begin{matrix}{a}^{′} & {b}^{′} \\ {c}^{′} & {d}^{′}\end{matrix} ] [ \begin{matrix}{D}_{1} \\ {D}_{2}\end{matrix} ] \qquad [ Expression 4 ]$$

The error detection unit 30a of the signal pre-processing unit 23a detects an error D1 (i.e., a difference D1) between the estimated signal E1 and the reception signal R1′ by comparing them with each other. Similarly, the error detection unit 30b of the signal pre-processing unit 23b detects an error D2 (i.e., a difference D2) between the estimated signal E2 and the reception signal R2′ by comparing them with each other.

The compensation coefficient calculation unit 31a of the signal pre-processing unit 23a calculates, by using the error D1, a compensation coefficient C1 by which the distortion compensation unit 32a compensates for the distortion, and outputs the calculated compensation coefficient C1 to the distortion compensation unit 32a. Similarly, the compensation coefficient calculation unit 31b of the signal pre-processing unit 23b calculates, by using the error D2, a compensation coefficient C2 by which the distortion compensation unit 32b compensates for the distortion, and outputs the calculated compensation coefficient C2 to the distortion compensation unit 32b. The distortion compensation units 32a and 32b compensate for the nonlinear distortions of the reception signals R′ by using the compensation coefficients C1 and C2, respectively. In this way, the receiver 20 can detect the error of the signal and calculate the compensation coefficient. Therefore, it becomes possible to compensate for nonlinear distortions in the distortion compensation unit 32, so that the signal quality in the communication path is improved.

As described in the background section, a radio communication apparatus needs to compensate for a nonlinear distortion, which is caused by a nonlinear device in an analog part of the apparatus, in a digital part thereof. Regarding the deterioration of a signal due to a nonlinear distortion, the influence of a nonlinear device (e.g., a device such as an amplifier) provided inside a transmitting apparatus is dominant, and a linearizer is typically used as a method for compensating for such a nonlinear distortion.

As an example of the method by which a transmitting apparatus compensates for a nonlinear distortion by using a linearizer, there is a method in which the amount of a nonlinear distortion of a nonlinear device provided inside a transmitting apparatus is estimated from a reception signal in a receiving apparatus, and the signal is compensated for the nonlinear distortion by generating a compensation coefficient. As described above, a distortion caused by a nonlinear device disposed on the transmitting apparatus side has a significant influence on the deterioration of the signal. Therefore, the above-described method is used in order to compensate for the distortion caused by the nonlinear device disposed on the transmitting apparatus side, and is often used especially when the distance between the modulation unit and the nonlinear device is large in the transmitting apparatus. It should be noted that when the transmission signal is a single signal (i.e., when there is only one transmitting station), the above-described method was also used for compensation for a distortion caused by a nonlinear device disposed on the receiving apparatus side.

However, in the case of a spatially-multiplexed communication method such as MIMO, since a PAPR (Peak-to-Average Power Ratio) of a multiplexed signal increases, a nonlinear distortion resulting from a nonlinear device disposed on the receiving apparatus side increases. Therefore, there has been a problem that even when the above-described method is used, the signal quality may deteriorate.

In recent years, the volume of communication in digital microwave communication apparatuses has been increasing, so there have been demands for an increase in the number of levels of signals and an improvement in the efficiency of the use of frequencies. In order to increase the number of levels of signals, it is necessary to compensate for nonlinear distortions caused by nonlinear devices disposed on the receiving apparatus side. However, the above-described method cannot be used together with the aforementioned communication method such as MIMO, so it has been a challenge to achieve both the increase in the number of levels of signals and the improvement in the efficiency of the use of frequencies.

In contrast, in the second example embodiment, the signal pre-processing unit 23, which includes the error detection unit 30, the compensation coefficient calculation unit 31, and the distortion compensation unit 32, is disposed in front of the signal separation unit 24. Therefore, as compared to the configuration according to the related art in which the distortion compensation unit is disposed behind the signal separation unit, it is possible to accurately compensate for a nonlinear distortion(s) in a signal(s). Therefore, it is possible to achieve both the increase in the number of levels of signals and the improvement in the efficiency of the use of frequencies.

Further, the signal separation unit 24 generates a plurality of signals for demodulating the transmission signals T1 and T2 as separated signals S1 and S2. Therefore, the signal pre-processing unit 23 accurately compensates for the distortions of the signals, so that the receiver 20 can accurately demodulate the transmission signals.

Further, in the second example embodiment, the reception signal estimation unit 26 estimates ideal reception signals E1 and E2 by using MIMO-specific signal separation information M′ and a plurality of demodulated signals separated by the signal separation unit 24. Then, the error detection unit 30 detects an error (i.e., a difference) between the estimated reception signal E and the reception signal R′ output from the nonlinear device 22 by comparing them with each other. The compensation coefficient calculation unit 31 calculates a distortion characteristic in the nonlinear device 22 based on this error, and calculates a compensation coefficient C for compensating for the calculated distortion characteristic. By the above-described configuration, the receiver 20 can compensate for nonlinear distortions in signals and improve the signal quality even when a communication method in which signals are spatially multiplexed is used.

Further, the reception signal estimation unit 26 can estimate the reception signal by using, as the demodulated signal, a demodulated signal which has been shaped and output by the Nyquist filter unit 28. Therefore, the reception signal estimation unit 26 can estimate the reception signal more accurately. Further, the signal pre-processing unit 23 can also accurately compensate for the nonlinear distortion based on the accurate estimation of the reception signal.

Further, the signal separation unit 24 can update the spatial multiplex matrix and its inverse matrix by using a predetermined signal(s) periodically transmitted from the transmitter 10. Therefore, the signal pre-processing unit 23 can accurately calculate an error D and a compensation efficient C even when the multiplexing of transmission signals is changed over time. Therefore, the receiver 20 can accurately compensate for nonlinear distortions in signals.

Further, the receiver 20 can, in its own apparatus, compensate for nonlinear distortions caused by a plurality of nonlinear devices 22 each of which outputs a signal containing a nonlinear distortion.

Note that, the reception signal estimation unit 26 may estimate one of the reception signals R1 and R2. The signal pre-processing unit 23a or 23b compensates for a nonlinear distortion as described above based on one of the estimated signals E1 and E2 output by the reception signal estimation unit 26. Further, even in the case where the number of channels of reception signals R is three or larger, the reception signal estimation unit 26 may estimate any number of reception signals R having at least one channel. The signal pre-processing unit(s) 23 corresponding to the estimated signal(s) compensates for a nonlinear distortion(s) as described above.

The Nyquist filter unit 28 may shape at least one of the signals output from the signal separation unit 24, instead of shaping all of them.

The transmitter 10 may transmit a predetermined known signal to the receiver 20 after transmitting an adjustment request signal to the receiver 20 when, for example, the radio-wave condition or the strength of the transmission signal has changed. Based on the received adjustment request signal, the receiver 20 determines that it is necessary to update the spatial multiplex matrix and its inverse matrix used by the signal separation unit 24. After that, the receiver 20 can update the spatial multiplex matrix and its inverse matrix used by the signal separation unit 24 by using the received predetermined signal.

Further, variations (i.e., modifications) similar to those for the configuration of the receiving apparatus 5 described in the Section (1-2) can be applied to the configuration of the receiver 20 according to the second example embodiment.

The first and second embodiments can be combined as desirable by one of ordinary skill in the art.

Note that the present disclosure is not limited to the above-described example embodiments, and they can be modified as appropriate without departing from the scope and spirit of the disclosure. For example, the number of channels of signals output by nonlinear devices is not limited to one, but may be two or more.

The apparatuses described in the Section (1-2) of the first example embodiment and in the second example embodiment can be applied, for example, to transmitting apparatuses for Fixed Wireless Access and apparatuses used in a radio base station for mobile devices, but the applications thereof are not limited to these examples. Further, one of examples of the radio communication method is digital microwave communication in which multiplexed signals can be transmitted/received, but the applications thereof are not limited to this example.

Although the present disclosure is described as a hardware configuration in the above-shown example embodiments, the present disclosure is not limited to the hardware configurations. Regarding this disclosure, the processes (the steps) performed by each apparatus (each of the signal processing apparatus, the transmitting apparatus, the receiving apparatus, the transmitter, and the receiver) described in the above-described example embodiments can also be implemented by having a processor provided inside a computer execute a computer program.

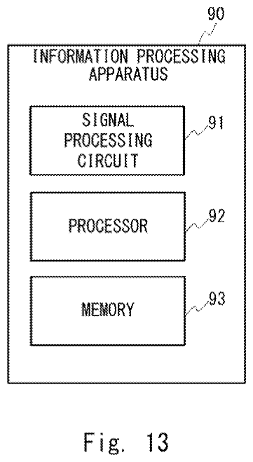

FIG. 13 is a block diagram showing an example of a hardware configuration of an information processing apparatus in which processes in each of the above-described example embodiments are performed. Referring to FIG. 13, this information processing apparatus 90 includes a signal processing circuit 91, a processor 92, and a memory 93. In FIG. 13, there is one signal processing circuit 91, one processor 92 and one memory 93 in the information processing apparatus 90, but there may be multiple of each.

The signal processing circuit 91 is a circuit for processing a signal according to the control by the processor 92. Note that the signal processing circuit 91 may include a communication circuit that receives a signal from a transmitting apparatus.

The processor 92 loads software (a computer program) from the memory 93 and executes the loaded software, and thereby performs the processes of each apparatus described in the above-described example embodiments. An example of the processor 92 is a CPU (Central Processing Unit), a MPU (Micro Processing Unit), an FPGA (Field-Programmable Gate Array), a DSP (Demand-Side Platform), or an ASIC (Application Specific Integrated Circuit), or two or more of them may be used in parallel.

The memory 93 is composed of a combination of a volatile memory and a non-volatile memory. The memory 93 may include a storage remotely disposed from the processor 92. In such a case, the processor 92 may access the memory 93 through an I/O (Input/Output) interface (not shown).

In the example shown in FIG. 13, the memory 93 is used to store a group of software modules. The processor 92 can load the software module group from the memory 93 and executes the loaded software module group, and thereby can perform the processes described in the above-described example embodiments.

As described above, one or a plurality of processors provided in each of the apparatuses in the above-described example embodiments executes one or a plurality of programs including a group of instructions for causing a computer to perform the algorithm described above with reference to the drawings, wherein the one or a plurality of programs is stored in at least one memory. By the above-described process, it is possible to implement a signal processing method described in each of the example embodiments.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Part of or all the foregoing embodiments can be described as in the following appendixes, but the present disclosure is not limited thereto.

(Supplementary Note 1)

A signal processing apparatus comprising at least one memory configured to store an instruction, and at least one processor configured to execute the instruction, the processor being further configured to:

compensate for a nonlinear distortion component of at least one input signal containing a nonlinear distortion among a plurality of multiplexed input signals, output the compensated input signal; and

generate a plurality of separated signals by separating the plurality of input signals including the output signal.

(Supplementary Note 2)

The signal processing apparatus described in Supplementary note 1, wherein

the signal processing apparatus is a receiving apparatus configured to acquire a plurality of reception signals in each of which a plurality of transmission signals is multiplexed, and

the plurality of input signals is the plurality of reception signals, and the at least one input signal containing the nonlinear distortion is one in which a nonlinear distortion occurs as the reception signal passes through a nonlinear device provided inside the signal processing apparatus.

(Supplementary Note 3)

The signal processing apparatus described in Supplementary note 2, wherein the processor is further configured to:

estimate at least one reception signal acquired by the signal processing apparatus by using signal separation information and the plurality of separated signals, the signal separation information being information that is used when the plurality of input signals including the output signal are separated into the plurality of separated signals; and

compensate for the nonlinear distortion component of the at least one input signal containing the nonlinear distortion based on an error between the estimated at least one reception signal and the at least one input signal.

(Supplementary Note 4)

The signal processing apparatus described in Supplementary note 3, wherein the processor is further configured to:

shape at least one of the plurality of generated separated signals, and output the at least one shaped separated signal, and

estimate at least one reception signal acquired by the signal processing apparatus by using the signal separation information and the plurality of separated signals including the output separated signal.

(Supplementary Note 5)

The signal processing apparatus described in Supplementary note 3, wherein the signal separation information is updated based on a predetermined transmission signal.

(Supplementary Note 6)

A communication system comprising:

one or a plurality of transmitting apparatuses configured to transmit a plurality of transmission signals; and

a receiving apparatus configured to acquire a plurality of reception signals in each of which the plurality of transmission signals is multiplexed, wherein

the receiving apparatus comprises:

a nonlinear device configured to output at least one of the plurality of reception signals;

at least one memory configured to store an instruction; and

at least one processor configured to execute the instruction, and

the processor is further configured to:

compensate for a nonlinear distortion component of at least one of the reception signals output from the nonlinear device, and output the compensated reception signal; and

generate a plurality of separated signals by separating the plurality of reception signals including the output signal.

(Supplementary Note 7)

The communication system described in Supplementary note 6, wherein the processor is further configured to:

estimate at least one reception signal acquired by the receiving apparatus by using signal separation information and the plurality of separated signals, the signal separation information being information that is used when the plurality of reception signals including the output signal are separated into the plurality of separated signals; and

compensate for the nonlinear distortion component of the at least one reception signal containing the nonlinear distortion based on an error between the estimated at least one reception signal and the at least one reception signal containing the nonlinear distortion.

(Supplementary Note 8)

A signal processing method comprising:

compensating for a nonlinear distortion component of at least one input signal containing a nonlinear distortion among a plurality of multiplexed input signals; and

generating a plurality of separated signals by separating the plurality of input signals including the compensated input signal.

(Supplementary Note 9)

A non-transitory computer readable medium storing a program for causing a computer to perform:

compensating for a nonlinear distortion component of at least one input signal containing a nonlinear distortion among a plurality of multiplexed input signals; and

generating a plurality of separated signals by separating the plurality of input signals including the compensated input signal.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A signal processing apparatus comprising at least one memory configured to store an instruction, and at least one processor configured to execute the instruction, the processor being further configured to:
compensate for a nonlinear distortion component of at least one input signal containing a nonlinear distortion among a plurality of multiplexed input signals, output the compensated input signal; and
generate a plurality of separated signals by separating the plurality of input signals including the output signal.

2. The signal processing apparatus according to claim 1, wherein
the signal processing apparatus is a receiving apparatus configured to acquire a plurality of reception signals in each of which a plurality of transmission signals is multiplexed, and
the plurality of input signals is the plurality of reception signals, and the at least one input signal containing the nonlinear distortion is one in which a nonlinear distortion occurs as the reception signal passes through a nonlinear device provided inside the signal processing apparatus.

3. The signal processing apparatus according to claim 2, wherein the processor is further configured to:
estimate at least one reception signal acquired by the signal processing apparatus by using signal separation information and the plurality of separated signals, the signal separation information being information that is used when the plurality of input signals including the output signal are separated into the plurality of separated signals; and
compensate for the nonlinear distortion component of the at least one input signal containing the nonlinear distortion based on an error between the estimated at least one reception signal and the at least one input signal.

4. The signal processing apparatus according to claim 3, wherein the processor is further configured to:
shape at least one of the plurality of generated separated signals, and output the at least one shaped separated signal, and
estimate at least one reception signal acquired by the signal processing apparatus by using the signal separation information and the plurality of separated signals including the output separated signal.

5. The signal processing apparatus according to claim 3, wherein the signal separation information is updated based on a predetermined transmission signal.

6. A communication system comprising:
one or a plurality of transmitting apparatuses configured to transmit a plurality of transmission signals; and
a receiving apparatus configured to acquire a plurality of reception signals in each of which the plurality of transmission signals is multiplexed, wherein
the receiving apparatus comprises:
a nonlinear device configured to output at least one of the plurality of reception signals;
at least one memory configured to store an instruction; and
at least one processor configured to execute the instruction, and
the processor is further configured to:
compensate for a nonlinear distortion component of at least one of the reception signals output from the nonlinear device, and output the compensated reception signal; and
generate a plurality of separated signals by separating the plurality of reception signals including the output signal.

7. The communication system according to claim 6, wherein the processor is further configured to:
estimate at least one reception signal acquired by the receiving apparatus by using signal separation information and the plurality of separated signals, the signal separation information being information that is used when the plurality of reception signals including the output signal are separated into the plurality of separated signals; and
compensate for the nonlinear distortion component of the at least one reception signal containing the nonlinear distortion based on an error between the estimated at least one reception signal and the at least one reception signal containing the nonlinear distortion.

8. A signal processing method comprising:
compensating for a nonlinear distortion component of at least one input signal containing a nonlinear distortion among a plurality of multiplexed input signals; and
generating a plurality of separated signals by separating the plurality of input signals including the compensated input signal.
